(19) United States
(12) Patent Application Publication
(10) Pub. No.: US 2020/0360115 A1
(43) Pub. Date: Nov. 19, 2020

(54) IMPLANT

(71) Applicant: Nobel Biocare Services AG, Kloten (CH)

(72) Inventor: Jan Hall, Goteborg (SE)

(21) Appl. No.: 16/886,261

(22) Filed: May 28, 2020

Related U.S. Application Data
(63) Continuation of application No. 10/582,919, filed on Apr. 12, 2007, now abandoned.

(30) Foreign Application Priority Data
Dec. 11, 2003 (SE) 0303322-2

(51) Int. Cl. A61C 8/00

(52) U.S. Cl. CPC A61C 8/0018; A61C 2008/0046; A61C 8/0077

(57) ABSTRACT

An implant (1) is designed to be fitted in a hole (2a) formed in jaw bone (2) and soft tissue (3). The implant comprises a portion (4b′) to be placed against the upper edge of the jaw bone. Along most of its peripheral extent, the portion (4b′) is provided with groves (9, 9′) or recesses designed to stimulate bone movement and ingrowth (10) of bone. The bone ingrowth (10) forms a barrier against substantial or visible subsidence, around the portion, of the bone (2) with overlying soft tissue (3). The invention permits a good esthetic result and prevents bacteria from penetrating into the internal parts of the implant and of the hole.

The present invention relates to an implant to be fitted in a hole in bone (jaw bone) with associated soft tissue. The implant comprises a portion that can be placed against the upper edge of the bone.

Such implants are already well known and are available on the market. The implant is generally provided with an outer thread by means of which it can be firmly screwed into the hole, which in turn can be threaded or unthreaded. In known implants, said portion bearing against the upper edge of the jaw bone can have a thread of general character or have ridges and depressions which extend, for example, in the vertical direction of the implant. The implant can comprise or support a spacer sleeve, prosthesis etc., which can be arranged with threads or surface-treated areas which can be placed against said upper edge of the jaw bone. These threads too are of a general character.

In the field of implants, a general problem is that of avoiding bone absorption, after a time, at the upper areas of the implant near its attachment components (spacers, prosthesis, etc.). Bone absorption means that said upper parts are exposed, which gives rise to poor esthetic results. This exposure also means that bacteria and organisms tending to cause inflammation can penetrate down to the lower parts of the implant. These disadvantages may in some cases lead to the implant having to be refitted. The object of the present invention is to solve this problem, inter alia.

The present invention uses the knowledge that certain specifically arranged grooves and/or recesses can provide for effective bone movement and ingrowth of bone into the actual groove and/or recesses. The bone movement and ingrowth stimulated by the groove and recesses gives rise to good integration between the implant part (titanium part) in question and the bone. Reference may be made in this respect to WO 97/05238 (Boyde) and to the patent application SE 02.03896-6 filed by the Applicant of the present patent application.

The features that can principally be regarded as characterizing the novel implant are, inter alia, that, along most of its peripheral extent, the portion is provided with grooves or recesses designed to stimulate bone movement and bone ingrowth and, by means of the bone ingrowth in the groove(s) or recesses, to form a barrier against substantial or visible subsidence, around the portion, of the bone with overlying soft tissue.

In one embodiment, the portion can comprise more than one groove or sets of recesses extending along most, preferably all, of the circumference. One or more of said grooves or recesses can consist of an arc-shaped or curved groove or set of recesses following a corresponding arc-shaped or curved bone (jaw bone). In a preferred embodiment, the groove or recess comprises a cross section with the basic shape of a semi-circle, semi-oval, hyperbola, etc. The cross section has a depth of 50-100 μm, preferably ca. 70 μm, and a width in the range of 70-160 μm, preferably of ca. 110 μm. Said counteraction or prevention of subsidence means there is improved contact and retention of the soft tissue against said upper parts too. In a preferred embodiment, the portion is arranged with a groove which extends around the outer surface and which is located at the upper/outer parts of the portion, said groove extending substantially in a cross section arranged substantially at right angles to the longitudinal axis of the implant. Further developments of the inventive concept are set out in the attached dependent claims.

By means of what has been proposed above, an effective barrier can be obtained by means of bone growing into the groove or recesses. Subsidence of bone and soft tissue is effectively avoided in this way. Exposure of implant parts lying below the portion of the implant in question and/or the implant attachment component is effectively avoided, which affords considerable advantages for purely esthetic reasons. In addition, penetration of bacteria or organisms of a kind tending to cause inflammation is also avoided. The grooves and/or recesses can be obtained by turning, milling, engraving, etching, shot-peening, laser machining, etc.

A presently proposed embodiment of an implant having the features characteristic of the invention will be described below with reference to the attached drawings, in which:

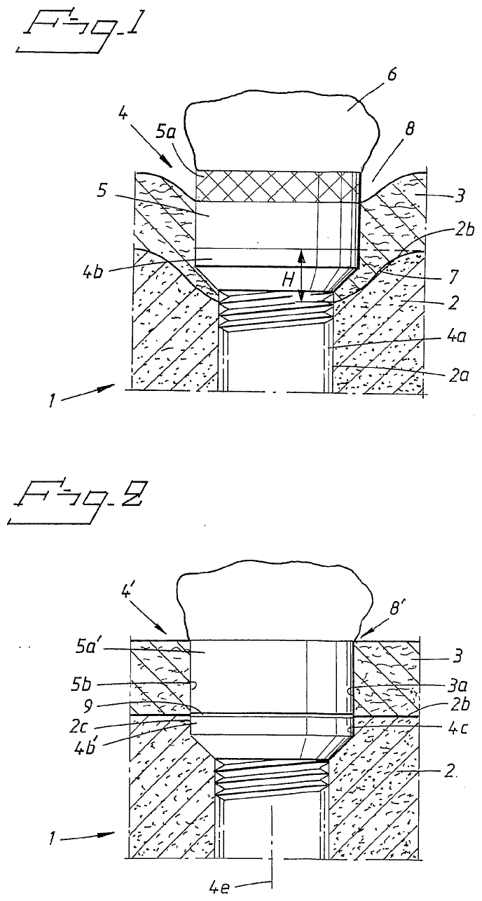

FIG. 1 shows a vertical cross section through parts of a previously known implant fitted in a hole in bone in the form of jaw bone and soft tissue,

FIG. 2 shows a vertical cross section through parts of the novel implant,

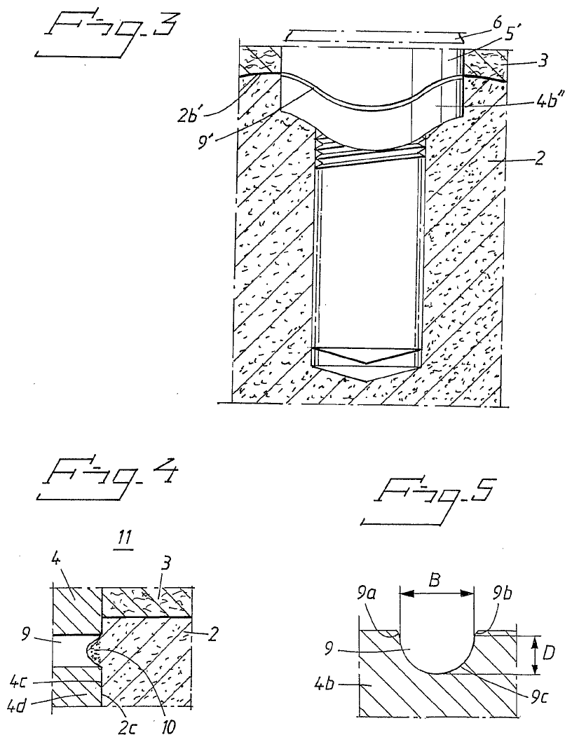

FIG. 3 shows a vertical cross section through a second embodiment of the novel implant fitted in a jaw bone,

FIG. 4 shows a vertical cross section through an enlargement of a groove structure in an implant (partially shown) and jaw bone,

FIG. 5 shows a greater enlargement compared to FIG. 4, illustrating the structure of a groove or recess used in conjunction with the implant according to FIGS. 2 and 3.

In FIG. 1, reference number 1 generally designates parts of a jaw bone 2 and soft tissue 3 lying over the latter. An implant is generally indicated by reference number 4 and is screwed into the jaw bone in a hole 2a formed in the latter. The hole can be threaded or unthreaded before the implant is screwed in. The implant in turn comprises an outer thread 4a by means of which the implant can be screwed into the hole 2a. At its upper parts, the implant is provided with a portion 4b that can initially be placed against an upper edge 2b of the jaw bone 2. The implant can comprise or be connected to an attachment component 5, for example in the form of a spacer sleeve. The attachment component will in turn support a prosthesis 6 shown symbolically in FIG. 1. FIG. 1 illustrates a case where bone absorption 7 has occurred in the jaw bone, which bone absorption means that the soft tissue subsides and that a conspicuous space 8 may form between in this case the upper parts 5a of the attachment component 5 and the bone. The space 8 can extend along much of the upper parts of the attachment components or implant. The space 8 in the present example thus has the effect that the upper portion 5a is exposed, which is unacceptable from the esthetic point of view. In FIG. 1, the extent of the bone absorption has been indicated by H, and this may often assume values of 1 mm or more.

In FIG. 2, an implant according to the invention has been indicated by 4′. The implant in FIG. 2 has a structure corresponding to the implant 4 in FIG. 1. In accordance with the concept of the invention, the portion 4b′ of the implant 4′ has been provided with an upper groove 9 which extends in the peripheral direction of the portion 4b′. In the illustrative embodiment shown, the groove extends all round the periphery in a cross-sectional plane at right angles to the plane of the figure in FIG. 2. The cross-sectional plane can be at right angles to the longitudinal axis 4e of the implant. In an alternative embodiment, the groove can extend along most of the periphery. The groove 9 is placed against the upper edge 2b of the bone 2. The outer surface of the portion has been indicated by 4c, and the opposite surface of the jaw bone by 2c. In the case illustrated according to FIG. 2, the groove 9 is greatly enlarged for the sake of clarity. The groove can in principle be replaced with a set of recesses arranged along all or most of the peripheral extent. The groove or recesses are of such a nature, according to the invention, that bone movement and bone ingrowth are stimulated by the groove or by the set of recesses themselves. The ingrowth of bone, which is described in more detail below, forms, at the top, a barrier preventing soft tissue 3 from subsiding in the event of bone absorption as shown in FIG. 1. The barrier thus prevents the bone 2 from subsiding along the outer surface of the upper parts of the implant and being followed by the soft tissue 3 in the manner shown in FIG. 1. By means of the invention, bone absorption is counteracted and only a small space 8′ (not shown) can form between the soft tissue 3 and the upper parts 5a′ of the portion. The soft tissue 3 can be allowed to bear with its inner surface 3a, in said hole, in contact against the outer surface 5b of the attachment component 5. The barrier thus prevents bone absorption, and the space 8′ in which bacteria may possibly accumulate is considerably reduced or completely reduced in its extent and depth. The attachment component can be integrated with or applied to the implant.

FIG. 3 shows a second embodiment of the implant fitted in the jaw bone 2 and the soft tissue 3. The implant structure can be the same as indicated above, except that the portion 4b″ is curved or arc-shaped so as to be able to follow a correspondingly curved or arc-shaped jaw bone edge 2b′. The portion supports or in this case includes an attachment component 5′ which, at the bottom, adjoins the curved portion and, at the top, supports a structure or prosthesis 6. In this case too, a groove 9′ is arranged at the upper parts of the portion. The groove 9′ is placed opposite the upper edge 2b′ of the jaw bone in a corresponding way to the groove 9 above. In this case too, the groove can extend along all or most of the peripheral extent of the portion. The groove 9′ can, in the same way as above, alternatively consist of a set of recesses arranged in a manner corresponding to the groove. Further grooves can be arranged substantially parallel to the groove 9′ on the portion 4b″.

FIG. 4 shows the groove structure in more detail. The groove 9 here is of the type which increases bone movement and ingrowth of bone in the groove by virtue of its structure. In FIG. 4, the ingrowth of bone is symbolized by 10. The implant or the implant part 4d below the groove has maintained its integration with the jaw bone 2, i.e. the surfaces 2c and 4c are closed tight. The oral cavity is here represented by 11.

In accordance with FIG. 5, the groove 9 is cup-shaped or semi-circular in cross section. As an alternative to the main semi-circular design, different variations of hyperbolic, elliptical or circular shapes are possible. Rectangular and square shapes can also be used. In these cases, however, it is important that the corners are rounded and are not sharp or provided with sharp edges. The groove or recess has been shown with transition parts 9a and 9b, and the actual cup shape or semi-circular shape by 9c. The width of the groove or of the recess is indicated by B and is measured at a position inside the bevels 9a and 9b. The depth of the groove is indicated by D. The width B is preferably ca. 110 μm and the depth D is preferably ca. 70 μm. As regards the extent of the groove or of the recesses in the circumferential direction, the expression “most of” means that at least 60% of the surface around the portion 4 will be provided with grooves and/or recesses. The groove or grooves or the recesses can be coordinated with correspondingly designed grooves and recesses on other parts of the implant.

The invention is not limited to the embodiment shown by way of example above, and instead it can be modified within the scope of the attached patent claims and the inventive concept.

1.-10. (canceled)

11. A dental implant configured to be inserted into a hole formed in jaw bone and overlying soft tissue, the dental implant comprising:
an upper portion to be placed against an upper edge of the jaw bone, the upper portion comprising at least one groove which extends all around an outer surface of the upper portion to form a closed loop and which extends substantially in a cross sectional plane at right angles to the longitudinal axis of the implant, said at least one groove configured to stimulate bone movement and bone ingrowth and through said bone ingrowth form a barrier against substantial or visible subsidence, around the portion, of the jaw bone with overlying soft tissue, said at least one groove having a cup-shaped cross section and having a depth of about 50-100 μm and having a width of about 70-160 μm, said at least one groove having transition parts between the outer surface of the upper portion and the remainder of the at least one groove, said transition parts being bevels; and
an outer thread by which the implant can be screwed into the hole formed in the jaw bone.

12. The dental implant as in claim 1, wherein the at least one groove comprises substantially parallel grooves arranged to be placed against the upper edge of the jaw bone.

13. The dental implant as in claim 1, wherein each groove has an arc-shaped portion that follows a corresponding arc-shaped jaw bone.

14. The dental implant as in claim 1, wherein each groove has a cross section of semi-circular shape.

15. The dental implant as in claim 1, wherein each groove has a cross section of hyperbola shape or semi-elliptical shape.

16. The dental implant as in claim 1, wherein each groove has a rectangular cross section with rounded corners.

17. The dental implant as in claim 1, wherein the at least one groove is located at an upper part of the upper portion.

18. The dental implant as in claim 1, wherein the at least one groove of the upper portion is coordinated with grooves on another portion of the dental implant.

19. The dental implant as in claim 1, wherein the depth of the groove is about 70 μm.

20. The dental implant as in claim 1, wherein the width of the groove is about 110 μm.

21. A method of placing a dental implant, the method comprising:
providing an implant having an upper portion comprising at least one groove which extends in a closed track around an outer surface of the upper portion and which extends substantially in a cross sectional plane at right angles to the longitudinal axis of the implant, said groove having a cup-shaped cross section and having a depth of about 50-100 μm and having a width of about 70-160 μm, said at least one groove having transition parts between the outer surface of the upper portion and the remainder of the at least one groove, said transition parts being bevels, the implant further comprising an outer thread by which the implant can be screwed into a hole formed in jaw bone of a patient;
installing the implant into the jaw bone of the patient; and
positioning the upper portion of the implant against an upper edge of the jaw bone, the groove stimulating bone movement and bone ingrowth to form a barrier against substantial or visible subsidence, around the portion, of the jaw bone with overlying soft tissue.

22. The method as in claim 21, further comprising aligning an arc-shaped portion of the implant to follow a correspondingly arc-shaped edge of the jaw bone.

23. The method as in claim 21, further comprising positioning the at least one groove below a top surface of the jaw bone adjacent the upper edge of the jaw bone.

24. The method as in claim 21, wherein the at least one groove has a cross section of semi-circular shape.

25. The method as in claim 21, wherein the at least one groove has a cross section of hyperbola shape or semi-elliptical shape.

26. The method as in claim 21, wherein the at least one groove has a rectangular cross section with rounded corners.

27. The method as in claim 21, wherein the at least one groove is located at an upper part of the upper portion.

28. The method as in claim 21, wherein the at least one groove of the upper portion is coordinated with grooves on another portion of the dental implant.

29. The method as in claim 21, wherein the depth of the at least one groove is about 70 μm.

30. The method as in claim 21, wherein the width of the at least one groove is about 110 μm.
